(19) United States
(12) Patent Application Publication
(10) Pub. No.: US 2024/0101305 A1
(43) Pub. Date: Mar. 28, 2024

(54) A Thermally Insulative Liner for Use in Packaging

(71) Applicant: Anglian Bespoke Corrugated and Packaging Ltd., Norfolk (GB)

(72) Inventors: Christopher Coles, Norfolk (GB); Daniel Foyster, Norfolk (GB)

(21) Appl. No.: 18/260,349

(22) PCT Filed: Dec. 23, 2021
(86) PCT No.: PCT/EP2021/087620

§ 371 Date: Jul. 5, 2023

(30) Foreign Application Priority Data
Jan. 5, 2021 (GB) 2100098.9

(51) Int. Cl. B65D 5/56; B65B 7/16; B65D 81/38

(52) U.S. Cl. CPC B65D 5/566; B65B 7/16; B65D 81/3858

(57) ABSTRACT

A thermally insulative liner for packaging includes a base, sidewalls extending from the base and defining an opening, and a cover for covering the opening. The cover includes first, second, and third segments. A first side of the first segment is hingedly attached to a sidewall such that the first segment is rotatable, from being aligned with that sidewall, in a first direction. A first side of the second segment is hingedly attached to a second side of the first segment such that the second segment is rotatable, from being aligned with the first segment, in the first direction. The third segment is hingedly attached to a second side of the second segment such that the third segment is rotatable, from being aligned with the second segment, in a second direction opposite to the first direction.

### TECHNICAL FIELD

The present invention relates to thermally insulative packaging and thermally insulating liners for packaging.

### BACKGROUND

User-assembled, or ‘flat-pack’, packaging is used in a variety of industries as a cost-effective and logistically straightforward solution to the problem of packaging and transporting goods.

In many applications, it is desirable to provide flat-pack packaging that packs in a space-efficient manner prior to assembly but nevertheless forms a robust and well-supported structure upon assembly. Such applications include, for example, the packaging of white goods, construction materials, and furniture.

In many applications, it is desirable to provide packaging that provides improved thermal insulation. For example, it is desirable in some applications to improve the heat retention of the goods packaged therein, thereby to house goods at a desired temperature above that of the ambient surroundings. Such applications include, for example, the distribution of perishable goods, hot or cooked foodstuffs, construction materials, and medical supplies.

Alternatively, it is desirable in other applications to mitigate heat transfer to the goods enclosed within the packaging, thereby to house goods at a desired temperature below that of the ambient surroundings. Such applications include, for example, the distribution of perishable goods, cold or raw foodstuffs, construction materials, and medical supplies.

### SUMMARY

The present inventors have identified that some conventional flat-pack packaging is difficult and costly to manufacture, is susceptible upon assembly to fatigue and breakage under heavy load, is insufficiently thermally insulating upon assembly for many applications, is prone to incomplete assembly and accidental spillage, breakage, or undesirable cooling/heating, is environmentally unsustainable to manufacture or dispose of, or combinations thereof.

Specifically, flat-pack packaging formed predominantly of flat sheet material may provide insufficient robustness and thermal insulation for many applications.

For some applications, flat-pack packaging formed predominantly of fluted or corrugated sheets may provide sub-optimal thermal insulation (because air can enter and exit the open-ended cavities defined by the flutes) and limited rigidity.

Therefore, it is desirable to provide flat-pack packaging that is simultaneously cost-effective to manufacture and distribute, sufficiently robust to mitigate the likelihood of packaging fatigue or breakage under load, sufficiently thermally insulating to improve the longevity of perishable or heat-sensitive goods enclosed therein, and at least partially auto-assembling or auto-sealing. It is more desirable still that such packaging be formed entirely of environmentally sustainable materials.

In a first aspect, there is provided a thermally insulative liner for packaging, the thermally insulative liner including a base, a plurality of sidewalls extending from the base, the plurality of sidewalls defining an opening to an internal volume, the opening being opposite to the base, and a cover configured to cover the opening. The cover comprises a first segment, a second segment, and a third segment. A first side of the first segment is hingedly attached to a first sidewall of the plurality of sidewalls such that the first segment is rotatable, from a position in which the first segment is parallel to and aligned with the first sidewall, in a first direction relative to the first sidewall. A first side of the second segment is hingedly attached to a second side of the first segment opposite to the first side of the first segment such that the second segment is rotatable, from a position in which the second segment is parallel to and aligned with the first segment, in the first direction. A first side of the third segment is hingedly attached to a second side of the second segment opposite to the first side of the second segment such that the third segment is rotatable, from a position in which the third segment is parallel to and aligned with the second segment, in a second direction opposite to the first direction.

The thermally insulative liner may include a first part and a second part that is separate from the first part. The first part may include the base, the first sidewall, and the cover, wherein the base, the first sidewall, and the cover are attached together. The second part may include the plurality of sidewalls other than the first sidewall, wherein the plurality of sidewalls other than the first sidewall are attached together.

A first side of the first sidewall may be hingedly attached to the base such that the first sidewall is rotatable, from a position in which the first sidewall is parallel to and aligned with the base, in the first direction.

The plurality of sidewalls may further include a second sidewall, a third sidewall and a fourth sidewall. A side of the second sidewall may be hingedly attached to a first side of the third sidewall such that the third sidewall is rotatable, from a position in which the third sidewall is parallel to and aligned with the second sidewall, in a third direction. A side of the fourth sidewall may be hingedly attached to a second side of the third sidewall opposite the first side of the third sidewall such that the fourth sidewall is rotatable, from a position in which the fourth sidewall is parallel to and aligned with the third sidewall, in the third direction.

One or more (e.g., each) of the base, the plurality of sidewalls, and the cover of the thermally insulative liner may include a cellular structure comprising a plurality of substantially sealed cells.

The cellular structure may be a structure selected from the group of structures consisting of a honeycomb structure and a prismatic columnar structure.

Each cellular structure may be sandwiched between a respective first sheet and a respective second sheet.

Each hinged attachment between segments may be by means of a respective hinge formed by a slit through the cellular structure and only one of the first sheet and the second sheet.

All of the slits of the first part and/or the second part may be substantially parallel to each other.

The thermally insulative liner may comprise one or more materials selected from the group of materials consisting of a recycled material, a recyclable material, a biodegradable material, paper, card, cardboard, wood, polymer, and a cellulose fibre material.

In a second aspect, there is provided thermally insulative packaging comprising outer packaging defining an internal volume, and a thermally insulative liner located within the internal volume of the outer packaging. The thermally insulative liner is in accordance with any preceding aspect.

The outer packaging may be a box including a box base, a plurality of box sidewalls extending from the base, the plurality of box sidewalls defining a box opening to the internal volume of the outer packaging, the box opening being opposite to the box base, and a box cover configured to cover the box opening.

When the box cover is arranged to cover the box opening, the third segment may be disposed between the box cover and the second segment, such that the box cover and the second segment are spaced apart, thereby to define a cavity therebetween.

The box cover may include a plurality of flaps hingedly attached to respective box sidewalls. When the plurality of flaps is arranged to cover the box opening, the third segment may be disposed between each of the flaps and the second segment.

In a third aspect, there is provided a method of assembling thermally insulative packaging including providing outer packaging, where the outer packaging defines an internal volume, and inserting a thermally insulative liner into the internal volume of the outer packaging. The thermally insulative liner is in accordance with any preceding aspect.

The method may include inserting the first part into the internal volume of the outer packaging such that the base is disposed against a base of the outer packaging, the first sidewall is disposed against a sidewall of the outer packaging, and the first section, the second section, and the third section of the cover are each substantially parallel with the first sidewall. The method may include inserting the second part into the internal volume of the outer packaging such that each sidewall of the second part is disposed against a respective sidewall of the outer packaging.

The method may further include inserting goods into the internal volume of the thermally insulative liner.

The method may include closing, by the cover, the opening of the thermally insulative liner, and closing, by a further cover of the outer packaging, a further opening to the internal volume of the outer packaging.

In a further aspect, there is provided a thermally insulative liner for packaging including a base, sidewalls extending from the base and defining an opening, and a cover for covering the opening, wherein the cover comprises first, second, and third segments. A first side of the first segment is hingedly attached to a sidewall such that the first segment is rotatable, from being aligned with that sidewall, in a first direction. A first side of the second segment is hingedly attached to a second side of the first segment such that the second segment is rotatable, from being aligned with the first segment, in the first direction. The third segment is hingedly attached to a second side of the second segment such that the third segment is rotatable, from being aligned with the second segment, in a second direction opposite to the first direction.

### BRIEF DESCRIPTION OF THE DRAWINGS

FIG. 1 is a schematic illustration (not to scale) showing a perspective view of a first part of a thermally insulative liner for packaging.

FIG. 2 is a schematic illustration (not to scale) showing a perspective view of a second part of the thermally insulative liner for packaging.

FIG. 3 is a process flow chart showing certain steps of a process for assembling the thermally insulative liner in a box.

FIG. 4 is an exploded perspective view showing assembly of the thermally insulative liner within the box.

FIG. 5 is a schematic illustration (not to scale) of a side view cross section of the thermally insulative liner within the box, in an open configuration.

FIG. 6 is a schematic illustration (not to scale) of a side view cross section of the thermally insulative liner within the box, in transition from the open configuration to a closed configuration.

FIG. 7 is a schematic illustration (not to scale) of a side view cross section of the thermally insulative liner within the box, in the closed configuration.

FIG. 8 is a schematic illustration (not to scale) of a perspective view of a further first part of the thermally insulative liner for packaging.

FIG. 9 is a schematic illustration (not to scale) of a side view cross section of the further first part within a box, in a closed configuration.

FIG. 10 is a schematic illustration (not to scale) of a side view cross section of a yet further first part of the thermally insulative liner for packaging within a box, in a closed configuration.

### DETAILED DESCRIPTION

It will be appreciated that relative terms such as above and below, horizontal and vertical, top and bottom, front and back, and so on, are used herein merely for ease of reference to the drawings, and these terms are not limiting as such, and any two differing directions or positions and so on may be implemented rather than truly above and below, horizontal and vertical, top and bottom, and so on.

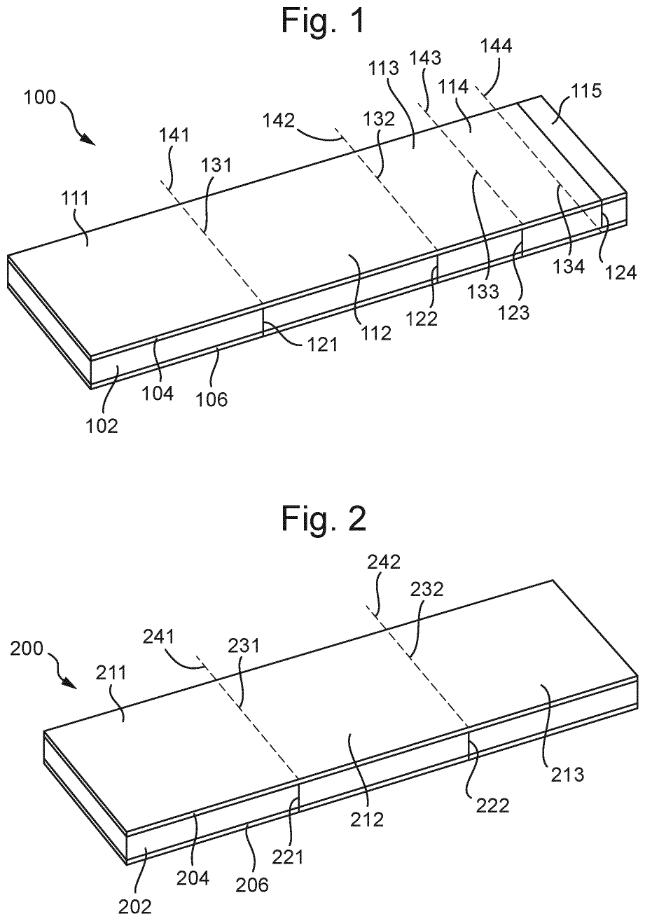

FIG. 1 is a schematic illustration (not to scale) showing a perspective view of a first part 100 of a thermally insulative liner for packaging.

In this embodiment, the first part 100 is an elongate sheet of material comprising a first core 102 sandwiched between a first layer 104 and a second layer 106 opposing the first layer 104.

In this embodiment, the first part 100 is divided into a first plurality of segments 111-115 by a first plurality of substantially parallel slits 121-124. Specifically, the first part 100 is divided into a first segment 111, a second segment 112, a third segment 113, a fourth segment 114, and a fifth segment 115 by the first plurality of slits 121-124. Each of the segments 111, 112, 113, 114, 115 is separated from an adjacent segment by a respective slit.

In this embodiment, the first layer 104 and the second layer 106 of each of the segments 111-115 extend in substantially parallel directions.

In this embodiment, each slit of the first plurality of slits 121-124 is a slit or cut spanning the entire width of each of the first core 102 and one of the first layer 104 and the second layer 106, in a direction substantially perpendicular to the direction in which the first layer 104 and the second layer 106 extend. Thus, each slit of the first plurality of slits 121-124 may be considered to be a transverse slit.

Specifically, in this embodiment, a first slit 121 separates the first segment 111 from the second segment 112. The first slit 121 is a slit or cut through the second layer 106 and the first core 102, and not through the first layer 104, thereby to define a first hinge 131. The first segment 111 and second segment 112 are hingedly connected at the first hinge 131 formed by the first layer 104. The hinged connection is such that the second segment 112 may rotate, from a position in which the second segment 112 is parallel to and aligned with the first segment 111, in a first direction relative to the first segment 111 about a first rotation axis 141.

Specifically, in this embodiment, a second slit 122 separates the second segment 112 from the third segment 113. The second slit 122 is a slit or cut through the second layer 106 and the first core 102, and not through the first layer 104, thereby to define a second hinge 132. The second segment 112 and third segment 113 are hingedly connected at the second hinge 132 formed by the first layer 104. The hinged connection is such that the third segment 113 may rotate, from a position in which the third segment 113 is parallel to and aligned with the second segment 112, in the first direction relative to the second segment 112 about a second rotation axis 142.

Specifically, in this embodiment, a third slit 123 separates the third segment 113 from the fourth segment 114. The third slit 123 is a slit or cut through the second layer 106 and the first core 102, and not through the first layer 104, thereby to define a third hinge 133. The third segment 113 and fourth segment 114 are hingedly connected at the third hinge 133 formed by the first layer 104. The hinged connection is such that the fourth segment 114 may rotate, from a position in which the fourth segment 114 is parallel to and aligned with the third segment 113, in the first direction relative to the third segment 113 about a third rotation axis 143.

Specifically, in this embodiment, a fourth slit 124 separates the fourth segment 114 from the fifth segment 115. The fourth slit 124 is a slit or cut through the first layer 104 and the first core 102, and not through the second layer 106, thereby to define a fourth hinge 134. The fourth segment 114 and fifth segment 115 are hingedly connected at the fourth hinge 134 formed by the second layer 106. The hinged connection is such that the fifth segment 115 may rotate, from a position in which the fifth segment 115 is parallel to and aligned with the fourth segment 114, in a second direction relative to the fourth segment 114, the second direction being opposite to the first direction, about a fourth rotation axis 144.

In this embodiment, each segment of the first plurality of segments 111-115 comprises a sandwiched arrangement of the first core 102, the first layer 104, and the second layer 106.

In this embodiment, the first core 102 of each segment is a honeycomb core, i.e., is formed of a honeycomb arrangement of material, for example a honeycomb arrangement of cellulose fiber. The honeycomb arrangement includes prismatic or columnar cavities defined by partitioning walls.

In this embodiment, the first layer 104 and second layer 106 of each segment are flat sheets of material, for example flat sheets of cellulose fiber. In the sandwiched arrangement of this embodiment, the first layer 104 and the second layer 106 of each segment abut, and lie substantially perpendicular to, the partitioning walls of the honeycomb first core 102. As such, the first layer 104 and second layer 106 of each segment may be considered to be closures of the prismatic or columnar cavities within the honeycomb first core 102 of each segment.

In this embodiment, a length of the first part 100 in a direction perpendicular to the rotation axes 141-144 is approximately 87.4 cm. In other embodiments, the length may be, for example, between 50 cm and 120 cm, for example between 70 cm and 100 cm, for example between 80 cm and 90 cm. In this embodiment, a height of the first part 100 in a direction parallel to the rotation axes 141-144 is approximately 31 cm. In other embodiments, the height may be, for example, between 10 cm and 50 cm, for example between 20 cm and 40 cm. In this embodiment, a width of the first part 100 in a direction from the first layer 104 to the second layer 106, i.e., in a direction perpendicular to that of the length and height of the first part 100, is approximately 1.7 cm. In other embodiments, the width may be, for example, between 1 cm and 3 cm, for example between 1.5 cm and 2 cm.

FIG. 2 is a schematic illustration (not to scale) showing a perspective view of a second part 200 of the thermally insulative liner for packaging.

In this embodiment, the second part 200 is an elongate sheet of material comprising a second core 202 sandwiched between a third layer 204 and a fourth layer 206 opposing the first layer 204.

In this embodiment, the second part 200 is divided into a second plurality of segments 211-213 by a second plurality of substantially parallel slits 221, 222. Specifically, the second part 200 is divided into a sixth segment 211, a seventh segment 212, and an eighth segment 213 by the second plurality of slits 221, 222. Each of the segments 211-213 is separated from an adjacent segment by a respective slit.

In this embodiment, the third layer 204 and the fourth layer 206 of each of the segments 211-213 extend in substantially parallel directions.

In this embodiment, each slit of the second plurality of slits 221, 222 is a slit or cut spanning the entire width of each of the second core 202 and one of the third layer 204 and the fourth layer 206, in a direction substantially perpendicular to the direction in which the third layer 204 and the fourth layer 206 extend. Thus, each slit of the second plurality of slits 221, 222 may be considered to be a transverse slit.

Specifically, in this embodiment, a fifth slit 221 separates the sixth segment 211 from the seventh segment 212. The fifth slit 221 is a slit or cut through the fourth layer 206 and the second core 202, and not through the third layer 204, thereby to define a fifth hinge 231. The sixth segment 211 and seventh segment 212 are hingedly connected at the fifth hinge 231 formed by the third layer 204. The hinged connection is such that the seventh segment 212 may rotate, from a position in which the seventh segment 212 is parallel to and aligned with the sixth segment 211, in the first direction relative to the sixth segment 211 about a fifth rotation axis 241.

Specifically, in this embodiment, a sixth slit 222 separates the seventh segment 212 from the eighth segment 213. The sixth slit 222 is a slit or cut through the fourth layer 206 and the second core 202, and not through the third layer 204, thereby to define a sixth hinge 232. The seventh segment 212 and eighth segment 213 are hingedly connected at the sixth hinge 232 formed by the third layer 204. The hinged connection is such that the eighth segment 213 may rotate, from a position in which the eighth segment 213 is parallel to and aligned with the seventh segment 212, in the first direction relative to the seventh segment 212 about a sixth rotation axis 242.

In this embodiment, each segment of the second plurality of segments 211-213 comprises a sandwiched arrangement of the second core 202, the third layer 204, and the fourth layer 206.

In this embodiment, the second core 202 of each segment is a honeycomb core, i.e., is formed of a honeycomb arrangement of material, for example a honeycomb arrangement of cellulose fiber. The honeycomb arrangement includes prismatic or columnar cavities defined by partitioning walls.

In this embodiment, the third layer 204 and fourth layer 206 of each segment are flat sheets of material, for example flat sheets of cellulose fiber. In the sandwiched arrangement of this embodiment, the third layer 204 and the fourth layer 206 of each segment abut, and lie substantially perpendicular to, the partitioning walls of the honeycomb second core 202. As such, the third layer 204 and fourth layer 206 of each segment may be considered to be closures of the prismatic or columnar cavities within the honeycomb second core 202 of each segment.

The first part 100 and second part 200 may therefore be considered to be of identical construction, i.e., to be formed of elongate sheets of the same sandwiched arrangement of core and layers.

In this embodiment, a length of the second part 200 in a direction perpendicular to the rotation axes 241-242 is approximately 82.3 cm. In other embodiments, the length may be, for example, between 50 cm and 120 cm, for example between 70 cm and 100 cm, for example between 80 cm and 90 cm. A height of the second part 200 in a direction parallel to the rotation axes 241-242 is approximately 25.6 cm. In other embodiments, the height may be, for example, between 10 cm and 50 cm, for example between 20 cm and 40 cm. A width of the second part 200 in a direction from the third layer 204 to the fourth layer 206, i.e., in a direction perpendicular to that of the length and height of the second part 200, is approximately 1.7 cm. In other embodiments, the width may be, for example, between 1 cm and 3 cm, for example between 1.5 cm and 2 cm.

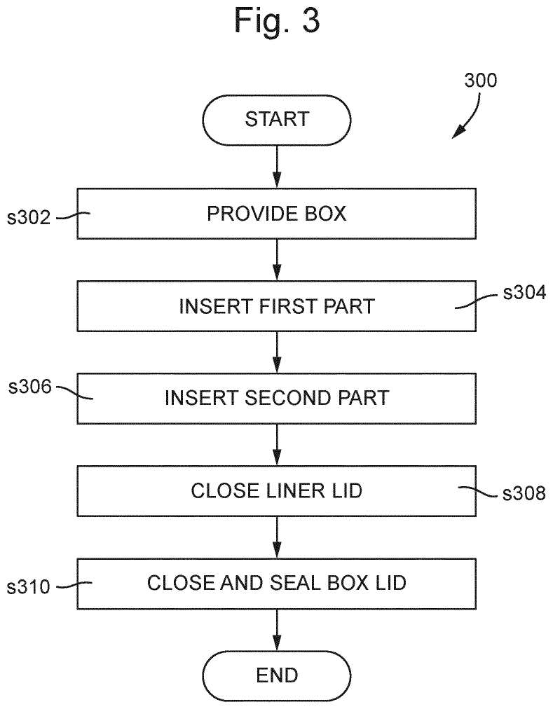

FIG. 3 is a process flow chart showing steps of a process 300 for assembling the thermally insulative liner in a box.

It should be noted that certain steps of the process 300 depicted in the flowchart of FIG. 3 and described above may be omitted, or such process steps may be performed in differing order to that presented above and shown in FIG. 3. Furthermore, although all the process steps have, for convenience and ease of understanding, been depicted as discrete temporally-sequential steps, some of the process steps may nevertheless in fact be performed simultaneously or in a temporally-overlapping manner, at least to some extent.

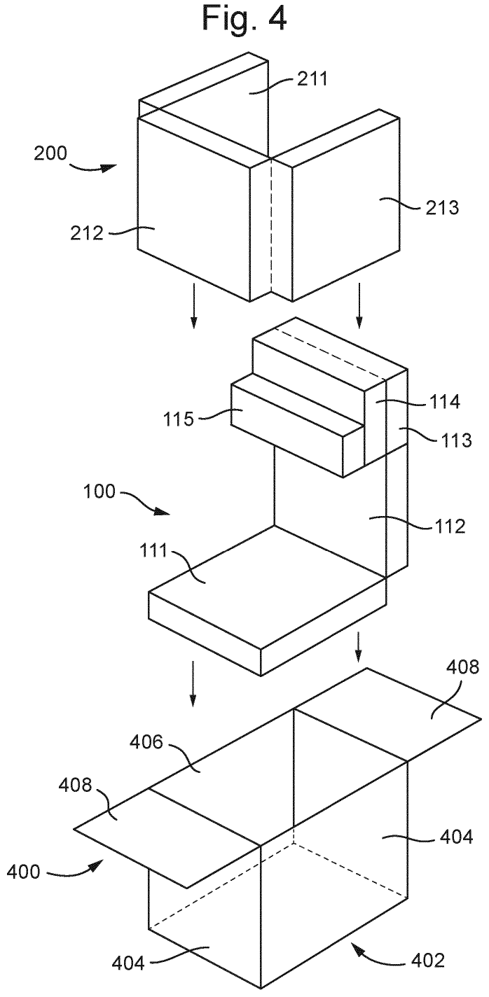

The below description of FIG. 3 refers to FIG. 4, which is a schematic illustration (not to scale) showing assembly of the thermally insulative liner in the box.

At step s302, the box 400 is provided. The box 400 comprises a base 402 and sidewalls 404. The sidewalls extend from the base 102. The sidewalls 404 define an opening 406 opposite to the base 402. The box 400 further comprises closing flaps 408 at the ends of the sidewalls 404 opposite the base 402.

In this embodiment, the third segment 113, the fourth segment 114, and the fifth segment 115 together form a cover for closing the thermally insulative liner across the opening 406. The third segment 113 may be considered to be a first segment of the cover. The fourth segment 114 may be considered to be a second segment of the cover. The fifth segment 115 may be considered to be a third segment of the cover.

At step s304, the first part 100 is inserted into the box 400 via the opening 406 (as depicted by arrows in FIG. 4).

Upon insertion of the first part 100 into the box 400, the first segment 111 of the first part 100 abuts, and lies substantially flush with, the base 402 of the box 400. That is to say that the first segment 111 substantially covers a top surface of the base 402 of the box 400.

The second segment 112 (which is rotated relative to the first segment 111 such that it is perpendicular to the first segment 111) abuts, and lies substantially flush with, one of the sidewalls 404 of the box 400. That is to say that the second segment 112 substantially covers an inner surface of one of the sidewalls 404 of the box 400.

Following step s304, in this embodiment, the third, fourth, and fifth segments 113, 114, 115 remain substantially parallel and aligned with each other. Thus, the majority of the opening 406 of the box 400 tends to be unobstructed, to not restrict the opening 406 or hinder the insertion at step s306 of the second part 200.

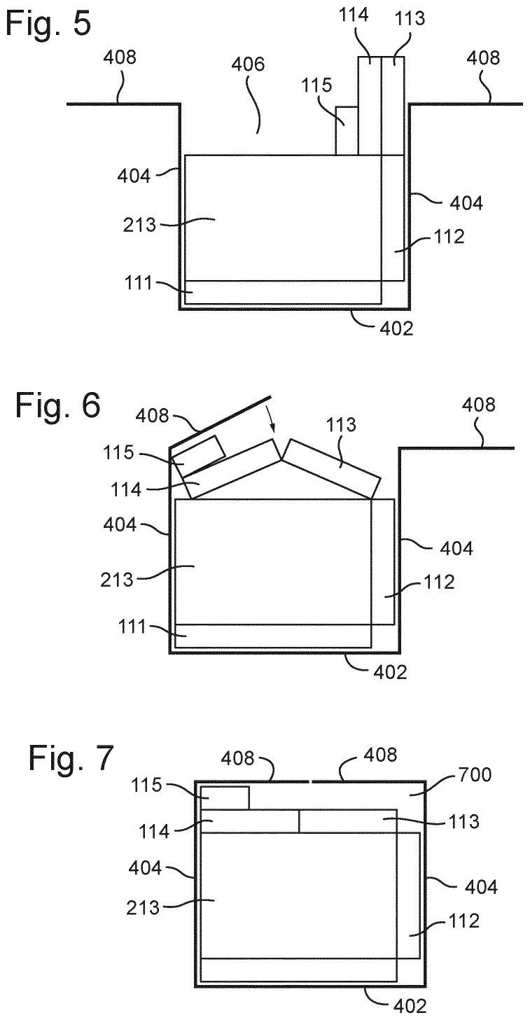

In other embodiments, however, the third, fourth, and fifth segments may adopt a position in which they abut, and lie flush with, each other following step s304 (see FIG. 5). In such other embodiments, the third, fourth, and fifth segments 113, 114, 115 adopting this configuration nevertheless leave the opening 406 of the box 400 sufficiently unobstructed to not hinder the insertion at step s306 of the second part 200. More specifically, the third, fourth, and fifth segments 113, 114, 115 of the first part 100 may be rotated relative to each other, thereby to abut, and lie flush with, each other, for example, at only one side of the opening 406. Each of the third, fourth, and fifth segments 113, 114, 115 of the first part 100 may therefore adopt a substantially upright position at only one side of the opening 406. Thus, the majority of the opening 406 of the box 400 tends to be unobstructed, to not restrict the opening 406 or hinder the insertion at step s306 of the second part 200.

At step s306, the second part 200 is inserted into the box 400 via the opening 406 (as depicted by further arrows in FIG. 4), thereby to provide the configuration shown in FIG. 5.

FIG. 5 is a schematic illustration (not to scale) showing a side view cross section of the first part 100 and second part 200 inserted into the box at step s306. (FIG. 5 depicts the packaging following execution of step s306.)

In this embodiment, each of the sixth segment 211, seventh segment 212, and eighth segment 213 is perpendicular to an adjacent segment of the second plurality of segments 211-213. Each of the sixth segment 211, seventh segment 212, and eighth segment 213 abuts, and lies substantially flush with, a respective one of the sidewalls 404 of the box 400. That is, each segment of the second plurality of segments 211-213 substantially covers a respective inner surface of one of the sidewalls 404 of the box 400. The sidewalls 404 covered by respective segments of the second part 200 are different sidewalls to the sidewalls 404 covered by respective segments of the first part 100.

Thus, following execution of step s306, a respective inner surface of each of the sidewalls 404 and the top surface of the base 402 is substantially covered by a respective segment of a part of the thermally insulative liner, thereby to line the box 400.

Optionally, following step s306, the packaging may be filled with goods. Examples of such goods include, but are not limited to, food, medical supplies, or construction materials.

As shown in FIG. 5, advantageously, the third, fourth, and fifth segments 113, 114, 115 of the first part 100 may be rotated relative to each other, thereby to abut, and lie flush, with each other, for example, at only one side of the opening 406. Each of the third, fourth, and fifth segments 113, 114, 115 of the first part 100 may therefore adopt a substantially upright position at only one side of the opening 406. Thus, the majority of the opening 406 of the box 400 tends to be unobstructed, thereby to facilitate the packing of goods within the packaging. Advantageously, the third, fourth, and fifth segments 113, 114, 115 tend to be held in these positions by respective contact forces experienced by respective abutting portions of the hingedly connected fourth and fifth segments 114, 115 through abutment with the second part 200. More advantageously still, in some embodiments, the third, fourth, and fifth segments 113, 114, 115 tend to be assisted in remaining in these positions by friction between those segments 113-115 and the respective adjacent sidewalls 404 of the box 400. In some embodiments, the third, fourth, and fifth segments 113, 114, 115 tend to be held in these positions solely by friction between those segments 113-115 and the respective adjacent sidewalls 404 of the box 400. This further tends to facilitate the packing of goods and tends to be particularly beneficial for assembly line packing of goods.

At step s308, the cover of the thermally insulative liner is closed, thereby to define an enclosed volume within the thermally insulative liner. FIG. 6 is a schematic illustration (not to scale) of a side view cross section of the thermally insulative liner showing a configuration of the cover of the thermally insulative liner during closure.

At step s308, the third segment 113 of the first part 100 is rotated, in the first direction, about the second hinge 132, relative to the second segment 112 of the first part 100. More specifically still, the third segment 113 is rotated, in the first direction, about the second hinge 132, thereby to move a top end of the third segment 113 (i.e., an end proximate the third hinge 133) towards the base 402 of the box 400. During said movement of the third segment 113, respective portions of the third and fourth segments 113, 114 abut respective top edges of the sixth and eighth segments 211, 213 (i.e., the respective edges of the sixth and eighth segments 211, 213 furthest from the base 402). Said movement of the third segment 113 is a rotation of the third segment 113 in the first direction relative to the second segment 112. As the third hinge 133 hingedly connects the third segment 113 to the fourth segment 114, rotation of the third segment 113 rotates the fourth segment 114 in the second direction relative to the second segment 112. Thus, movement of the top end of the third segment 113 towards the base 402 of the box 400 effects simultaneous movement of a top end of the fourth segment 114 towards the base 402 of the box 400.

In this embodiment, the respective portions of the third and fourth segments 113, 114 may be brought to lie flush with respective top edges of the sixth and eighth segments 211, 213 with which they abut, i.e., brought to lie substantially parallel with the first segment 111 and the base 402. More specifically, in this embodiment, the third and fourth segments 113, 114 of the liner may first be manually manipulated to adopt positions in which they together extend across the opening 406 of the box 400 (for example in FIG. 6). The third and fourth segments 113, 114 may then be moved, by rotation of the third segment 113 and/or the fourth segment 114, to lie flush with respective top edges of the sixth and eighth segments 211, 213, thereby to close the thermally insulative liner.

In other embodiments, the fourth segment 114 may be considered to act as a cam that rides along respective top ends of the sixth and eighth segments 211, 213 during rotation of said fourth segment 114. In this manner, respective portions of the third and fourth segments 113, 114 may be brought to lie flush with respective top edges of the sixth and eighth segments 211, 213 with which they abut, i.e., brought to lie substantially parallel with the first segment 111 and the base 402. That is, the third and fourth segments 113, 114 may be moved, by rotation of the third segment 113, to extend together across the opening 406 of the box, thereby to close the thermally insulative liner.

In the closed configuration of the liner, the first, second, third, fourth, sixth, seventh, and eighth segments 111, 112, 113, 114, 211, 212, 213 of the thermally insulative liner together define therein an enclosed volume. Thus, the liner may be considered to be in a closed configuration. (FIG. 7 depicts the liner in the closed configuration.)

At step s310, the box 400 is closed is closed and sealed. In particular, the closing flaps 408 are aligned and sealed together, thereby to form a unitary box lid.

Specifically, the closing flaps 408 of the box 400 are rotated relative to the sidewalls 404 to which they adjoin, thereby to form the unitary box lid of the box 400. (Rotation of the closing flaps 408 relative to the sidewalls 404 is depicted by an arrow in FIG. 6.)

Thus, a process 300 for assembling the thermally insulative liner in a box is provided.

FIG. 7 is a schematic illustration (not to scale) of a side view cross section of the thermally insulative liner in the closed configuration following formation of the unitary box lid, i.e., following execution of the process 300.

A closing force applied by one of the closing flaps 408 to the fifth segment 115 of the first part 100 causes abutment of the fifth segment 115 with the fourth segment 114. The closing force causes rotation of the fourth segment 114 in the second direction relative to the second segment 112. As the third hinge 133 hingedly connects the third segment 113 to the fourth segment 114, rotation of the fourth segment 114 in the second direction relative to the second segment 112 rotates the third segment 113 in the first direction relative to the second segment 112. Thus, movement of the top end of the fourth segment 114 towards the base 402 of the box 400 effects simultaneous movement of a top end of the third segment 113 towards the base 402 of the box 400.

In this embodiment, before closing the closing flaps 408, the third and fourth segments 113, 114 may first together be manipulated to extend across the opening 406 (i.e., in an intermediate configuration similar to that of FIG. 6). The third and fourth segments 113, 114 may then be moved, by rotation of the third segment 113 and/or the fourth segment 114 by one or both of the closing flaps 408, to lie flush with respective top edges of the sixth and eighth segments 211, 213, thereby to close the thermally insulative liner.

In other embodiments, the fourth segment 114 may be considered to act as a cam that rides along respective top edges of the sixth and eighth segments 211, 213 during rotation of said fourth segment 114. In this manner, respective portions of the third and fourth segments 113, 114 may be brought to lie flush with respective top edges of the sixth and eighth segments 211, 213 with which they abut, i.e., brought to lie substantially parallel with the first segment 111 and the base 402.

Thus, in this and other embodiments, the closed configuration of the thermally insulative liner obtained by execution of step s308 may advantageously be achieved, starting from an intermediate configuration of the thermally insulative liner (for example, the intermediate configuration depicted in FIG. 6), without contact of the thermally insulative liner with any object other than one or more of the closing flaps 408. (The intermediate configuration is a configuration obtained during execution of step s308, i.e., occurring temporally between the start of step s308 and the end of step s308.) That is, the liner may transition from the intermediate configuration to the closed configuration without being directly handled by a packager. Thus, the liner may be considered to operate in an at least partially auto-sealing manner.

In other embodiments, the closed configuration of the thermally insulative liner obtained by execution of step s308 may be achieved, starting from the orientation in the open configuration of the thermally insulative liner (as depicted in FIG. 5), without contact of the thermally insulative liner with any object other than one or more of the closing flaps 408. That is, the liner may transition from the open configuration to the closed configuration without being directly handled by a packager. Thus, the liner may be considered to operate in an auto-sealing manner.

As described above, the thermally insulative liner tends to be at least partially automatically sealing, for example by closure of the closing flaps 408 to form the unitary box lid at step s310. Thus, incomplete or incorrect execution of step s308 (closure of the thermally insulative liner) tends to be completed or corrected by execution of step s310. More specifically, incomplete of incorrect execution of step s308 (closure of the thermally insulative liner) tends to be completed or corrected by closure of the closing flaps 408 to form the unitary box lid. Advantageously, step s310 may be executed by relatively inexpensive and failsafe means, for example by mechanical closing/sealing means. Thus, the risk of incorrect or incomplete closure of the packaging tends to be reduced. This tends to mitigate the risk of spillages, breakages or undesirable cooling/heating of the packaged goods, at low effort and cost to the packager.

However, more advantageously still, the thermally insulative liner in the closed configuration tends to resist accidental opening even when the closing flaps 408 are not properly sealed to form the unitary box lid at step s310. More specifically, friction between the third and fourth segments 113, 114 forming part of the cover of the liner and respective portions of the sixth, seventh, and eighth segments 211, 212, 213 with which the third and fourth segments 113, 114 abut tends to resist movement of the third and fourth segments 113, 114 away from their horizontal orientation in the closed configuration.

As shown in FIG. 5, the second and third hinges 133, 134 between the third, fourth, and fifth segments 113, 114, 115 allow the third and fourth segments 113, 114 and the fourth and fifth segments 114, 115, respectively, to lie flush with each other when the thermally insulative liner is in the open configuration. Advantageously, this tends to maximise the fraction of the opening 406 left unobstructed, thereby to facilitate easy packing of goods into the packaging.

More advantageously still, hinging of the third, fourth, and fifth segments 113, 114, 115 allows abutment of a respective portion of each of the fourth and fifth segments 114, 115 with the respective top end of the sixth and eighth segments 211, 213 of the second part 200, when the packaging is in the open configuration shown in FIG. 5. Advantageously, the third, fourth, and fifth segments 113, 114, 115 tend to be held in these positions by friction between those segments 113-115 and the respective adjacent sidewalls 404 of the box 400. More advantageously still, the third, fourth, and fifth segments 113, 114, 115 tend to be held in these positions by respective contact forces experienced by respective abutting portions of the hingedly connected fourth and fifth segments 114, 115. This further tends to facilitate the packing of goods and tends to be particularly beneficial for assembly line packing of goods.

A further advantage is that the fifth segment 115 may be used as a handle. The handle may be used, for example, to open and close the liner. This tends to ease and speed packing/unpacking, and additionally tends to reduce or eliminate the need to handle the third and fourth segments 113, 114 during assembly and opening/closing, thereby to reduce wear and tear or damage of the third and fourth segments 113, 114. In particular, it is especially advantageous to reduce the wear and tear or damage of the third and fourth segments 113, 114 where they provide a predominant fraction of the thermally insulative effect, i.e., when it is desirable to mitigate, in particular, heat transfer across a top wall of the packaging, as is the case when packaging heated goods (for example, hot food).

An advantage of thermally insulative liner is that the sandwiched arrangement of layers forming each segment tends to provide improved thermal insulation.

In the above embodiments, the first, second, third, and fourth layers of each segment may be considered to be closures of the prismatic or columnar cavities within the honeycomb core of each segment. The entrance or exit of air from the honeycomb cavities is thus inhibited. This tends to greatly reduce the rate of heat transfer along the prismatic or columnar cavities of the honeycomb core. Thus, the thermally insulative liner having a sandwiched arrangement of material layers tends to provide for improved thermal insulation of the packaging.

In particular, in the above embodiments, the sandwiched arrangement of material layers within each segment of the thermally insulative liner abutting a wall of the box 400 tends to reduce a rate of heat transfer across the segment, i.e., from an exterior surface of the first/third layer to an exterior surface of the second/fourth layer. Thus, a rate of heat transfer between the enclosed volume of the thermally insulative liner and the base 402, and sidewalls 404, of the box 400 tends to be reduced. The longevity of perishable goods, such as foodstuffs and medical supplies, enclosed within thus tends to be improved.

In particular, in the above embodiments, when the thermally insulative liner is in the closed configuration, the sandwiched arrangement of material layers within each of the third, fourth, and fifth segments 113, 114, 115 tends to reduce a rate of heat transfer between the enclosed volume of the liner and the unitary box lid of the box 400. The longevity of perishable goods, such as foodstuffs and medical supplies, enclosed within thus tends to be further improved.

Referring to FIG. 7, in the above embodiments, there is defined a cavity 700 between the box 400 and the third, fourth, and fifth segments 113, 114, 115. The air within the cavity 700 tends to further reduce the rate of heat transfer between the enclosed volume of the thermally insulative liner and the unitary box lid of the box 400. The longevity of perishable goods, such as foodstuffs and medical supplies, enclosed within the thermally insulative liner thus tends to be further improved.

The cavity 700 formed between the box 400 and the third, fourth, and fifth segments 113, 114, 115 may also be used as additional storage space for goods, separate from the possibly temperature-sensitive goods within the enclosed volume of the thermally insulative liner.

In the above embodiments, the thermally insulative liner tends to reduce the rate of heat transfer between the enclosed volume of the thermally insulative liner and the box 400. Thus, a need for the box or other outer packaging of the packaging to be highly thermally insulative tends to be reduced. This tends to allow for reduced cost of manufacture of the box or other outer packaging.

In the above embodiments, the thermally insulative liner can be considered, at least to some degree, to be auto-sealing. Thus, a want to fastidiously secure the seal of the box or other outer packaging of the packaging (i.e., the risk of spillages, breakages or undesirable heating/cooling of the enclosed goods should said sealing fail) tends to be reduced. This tends to allow for reduced cost of manufacture and/or assembly of the box or other outer packaging.

In the above embodiments, abutment, with respective walls of the box, of the thermally insulative liner of sandwiched construction tends to greatly increase the rigidity and tensile strength of the box or outer packaging. The condition and longevity of the outer packaging therefore tends to be improved by its lining with the thermally insulative liner, thereby to provide robust packaging.

In the above embodiments, the first part 100 and second part 200 of the thermally insulative liner may be considered to be of identical construction, i.e., to be formed of elongate sheets of the same sandwiched arrangement of core and layers. This tends to allow for easier manufacture by existing methods, and the manufacturing time and cost tend to be reduced.

In the above embodiments, the slits of the first plurality of slits 121-124 within the first part 100 are substantially parallel. The slits of the second plurality of slits 221-224 within the second part 200 are also substantially parallel. Thus, the first part 100 and second part 200 of the thermally insulative liner are more easily manufactured by existing methods, and the manufacturing time and cost tend to be further reduced.

In the above embodiments, the first part 100 comprises a fifth segment 115, thereby to form a handle of the cover for opening and closing the packaging. However, in other embodiments, the handle may be formed of more than one segment, for example two segments, for example three segments, or for example four segments.

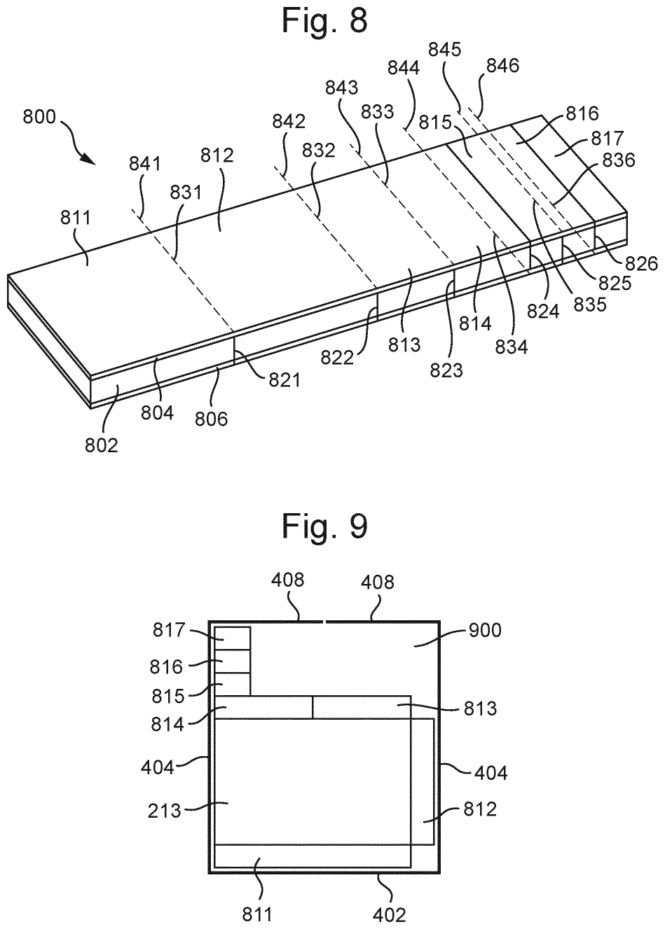

FIG. 8 is a schematic illustration (not to scale) of a perspective view of one such further embodiment. More specifically, FIG. 8 depicts a further first part 800 of a thermally insulative liner for packaging, the further first part 800 having a handle formed of three segments: a fifth segment 815, a sixth segment 816, and a seventh segment 817.

In this embodiment, the further first part 800 is an elongate sheet of material comprising a third core 802 sandwiched between a fifth layer 804 and a sixth layer 806 opposing the fifth layer 804.

In this embodiment, the further first part 800 is divided into a third plurality of segments 811-817 by a third plurality of substantially parallel slits 821-826. Specifically, the further first part 800 is divided into a ninth segment 811, a tenth segment 812, an eleventh segment 813, a twelfth segment 814, a thirteenth segment 815, a fourteenth segment 816, and a fifteenth segment 817, by the third plurality of slits 821-826. Each of the segments 811-817 is separated from an adjacent segment by a respective slit of the third plurality of slits 821-826.

In this embodiment, the fifth layer 804 and the sixth layer 806 of each of the ninth, tenth, eleventh, twelfth, thirteenth, fourteenth, and fifteenth segments 811-817 extend in substantially parallel directions.

In this embodiment, each slit of the third plurality of slits 821-826 is a slit or cut spanning the entire width of each of the third core 802 and one of the fifth layer 804 and the sixth layer 806, in a direction substantially perpendicular to the direction in which the fifth layer 804 and the sixth layer 806 extend. Thus, each slit of the third plurality of slits 821-826 may be considered to be a transverse slit.

Specifically, in this embodiment, a seventh slit 821 separates the ninth segment 811 from the tenth segment 812. The seventh slit 821 is a slit or cut through the sixth layer 806 and the third core 802, and not through the fifth layer 804, thereby to define a seventh hinge 831. The ninth segment 811 and tenth segment 812 are hingedly connected at the seventh hinge 831 formed by the fifth layer 804. The hinged connection is such that the tenth segment 812 may rotate, from a position in which the tenth segment 812 is parallel to and aligned with the ninth segment 811, in a first direction relative to the ninth segment 811 about a seventh rotation axis 841.

Specifically, in this embodiment, an eighth slit 822 separates the tenth segment 812 from the eleventh segment 813. The eighth slit 822 is a slit or cut through the sixth layer 806 and the third core 802, and not through the fifth layer 804, thereby to define an eighth hinge 832. The tenth segment 812 and eleventh segment 813 are hingedly connected at the eighth hinge 832 formed by the fifth layer 804. The hinged connection is such that the eleventh segment 813 may rotate, from a position in which the eleventh segment 813 is parallel to and aligned with the tenth segment 812, in the first direction relative to the tenth segment 812 about an eighth rotation axis 842.

Specifically, in this embodiment, a ninth slit 823 separates the eleventh segment 813 from the twelfth segment 814. The ninth slit 823 is a slit or cut through the sixth layer 806 and the third core 802, and not through the fifth layer 804, thereby to define a ninth hinge 833. The eleventh segment 813 and twelfth segment 814 are hingedly connected at the ninth hinge 833 formed by the fifth layer 804. The hinged connection is such that the twelfth segment 814 may rotate, from a position in which the twelfth segment 814 is parallel to and aligned with the eleventh segment 813, in the first direction relative to the eleventh segment 813 about a ninth rotation axis 843.

Specifically, in this embodiment, a tenth slit 824 separates the twelfth segment 814 from the thirteenth segment 815. The tenth slit 824 is a slit or cut through the fifth layer 804 and the third core 802, and not through the sixth layer 806, thereby to define a tenth hinge 834. The twelfth segment 814 and thirteenth segment 815 are hingedly connected at the tenth hinge 834 formed by the sixth layer 806. The hinged connection is such that the thirteenth segment 815 may rotate, from a position in which the thirteenth segment 815 is parallel to and aligned with the twelfth segment 814, in a second direction relative to the twelfth segment 814 about a tenth rotation axis 844. The second direction is opposite to the first direction.

Specifically, in this embodiment, an eleventh slit 825 separates the thirteenth segment 815 from the fourteenth segment 816. The eleventh slit 825 is a slit or cut through the sixth layer 806 and the third core 802, and not through the fifth layer 804, thereby to define an eleventh hinge 835. The thirteenth segment 815 and fourteenth segment 816 are hingedly connected at the eleventh hinge 835 formed by the fifth layer 804. The hinged connection is such that the fourteenth segment 816 may rotate, from a position in which the fourteenth segment 816 is parallel to and aligned with the thirteenth segment 815, in the first direction relative to the thirteenth segment 815 about an eleventh rotation axis 845.

Specifically, in this embodiment, a twelfth slit 826 separates the fourteenth segment 816 from the fifteenth segment 817. The twelfth slit 826 is a slit or cut through the fifth layer 804 and the third core 802, and not through the sixth layer 806, thereby to define a twelfth hinge 836. The fourteenth segment 816 and fifteenth segment 817 are hingedly connected at the twelfth hinge 836 formed by the sixth layer 806. The hinged connection is such that the fifteenth segment 817 may rotate, from a position in which the fifteenth segment 817 is parallel to and aligned with the fourteenth segment 816, in the second direction relative to the fourteenth segment 816 about a twelfth rotation axis 846.

In this embodiment, each segment of the third plurality of segments 811-817 comprises a sandwiched arrangement of the third core 802, the fifth layer 804, and the sixth layer 806.

In this embodiment, the third core 802 of each segment is a honeycomb core, i.e., is formed of a honeycomb arrangement of material, for example a honeycomb arrangement of cellulose fibre. The honeycomb arrangement includes prismatic or columnar cavities defined by partitioning walls.

In this embodiment, the fifth layer 804 and sixth layer 806 of each segment are flat sheets of material, for example flat sheets of cellulose fibre. In the sandwiched arrangement of this embodiment, the fifth layer 804 and the sixth layer 806 of each segment abut, and lie substantially perpendicular to, the partitioning walls of the honeycomb third core 802. As such, the fifth layer 804 and sixth layer 806 of each segment may be considered to be closures of the prismatic or columnar cavities within the honeycomb third core 802 of each segment.

In this embodiment, a length of the further first part 800 in a direction perpendicular to the rotation axes 841-846 is approximately 102.5 cm. In other embodiments, the length may be, for example, between 50 cm and 150 cm, for example between 70 cm and 130 cm, for example between 90 cm and 110 cm. In this embodiment, a height of the further first part 800 in a direction parallel to the rotation axes 841-846 is approximately 41.5 cm. In other embodiments, the height may be, for example, between 20 cm and 60 cm, for example between 30 cm and 50 cm. In this embodiment, a width of the further first part 800 in a direction from the fifth layer 804 to the sixth layer 806, i.e., in a direction perpendicular to that of the length and height of the further first part 800, is approximately 2 cm. In other embodiments, the width may be, for example, between 1 cm and 3 cm, for example between 1.5 cm and 2.5 cm.

In this embodiment, the thermally insulative liner, and the packaging of which it may form a part, is assembled in the same manner as in previous embodiments. The eleventh and twelfth segments 813, 814 of the further first part 800 of the thermally insulative liner may be brought parallel with the base 402 of the box 400 in the same way as the third and fourth segments 113, 114 of the embodiment in FIGS. 4-7, thereby to provide a closed configuration of the liner. The thirteenth, fourteenth, and fifteenth segments 815, 816, 817 together form a handle of the cover of the thermally insulative liner, the handle being extended in length compared to that of the previous embodiments. Advantageously, this provides improved ease of opening/closing of the cover of the thermally insulative liner.

FIG. 9 is a schematic illustration (not to scale) of a side view of the further first part 800, in the closed configuration, and the second part 200 within the box 400.

As shown in FIG. 9, when the liner is in the closed configuration, there is provided a cavity 900 of increased height compared to the cavity 700 of certain above embodiments, the cavity 900 being defined between the box 400 and the eleventh, twelfth, thirteenth, fourteenth, and fifteenth segments 813, 814, 815, 816, 817. The larger volume of air within the cavity, compared with that of previous embodiments, tends to further reduce the rate of heat transfer between the enclosed volume of the thermally insulative liner and the unitary box lid of the box 400. The longevity of perishable goods, such as foodstuffs and medical supplies, enclosed within the thermally insulative liner thus tends to be further improved.

The larger cavity also provides larger additional storage space for goods, separate from the possibly temperature-sensitive goods within the enclosed volume of the thermally insulative liner.

In the above embodiments, the segments forming the handle of the thermally insulative liner, i.e., the segments of the first/further first part that are respectively stacked when the thermally insulative liner is in the closed configuration (as in FIGS. 7 and 9), do not extend far from the sidewall 404 along a direction parallel to the unitary box lid of the box 400. Thus, in those embodiments, the volume of the cavity 700 defined between the box 400 and the third, fourth, and fifth segments 113, 114, 115 (as in the embodiment in FIG. 7) or volume of the cavity 900 defined between the box 400 and the eleventh, twelfth, thirteenth, fourteenth, and fifteenth segments 813, 814, 815, 816, 817 (as in the embodiment in FIG. 9) tends to be maximised.

In other embodiments, however, the length of one or more of the segments forming the handle may be increased to provide a handle that extends more than halfway from one sidewall 404 to another sidewall 404, when the thermally insulative liner is in the closed configuration.

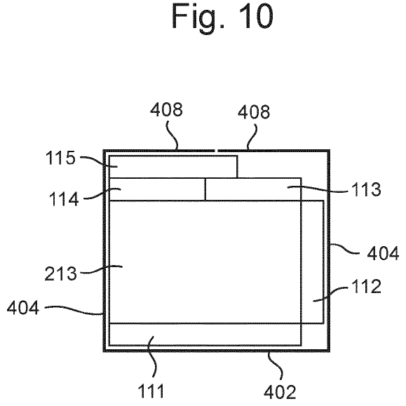

For example, FIG. 10 is a schematic illustration (not to scale) of a side view of one such further embodiment. In this embodiment, the fifth segment 115 has a length greater than half that of the unitary box lid of the box 400. As shown in FIG. 10, when the thermally insulative liner is in the closed configuration, the fifth segment 115 supportively contacts both closing flaps 408 of the box 400. That is, the closing flap 408 adjoining the sidewall 404 furthest from the fourth hinge 134 is at least partially supported by the fifth segment 115 when the thermally insulative liner is in the closed configuration. Advantageously, this tends to provide increased strength to the unitary box lid of the box 400, in particular allowing separate boxes to be stacked without damage to the box 400 and the thermally insulative liner and goods therein. The risk of spillages or breakages due to inverting, jostling, or otherwise mishandling the box during assembly or transit also tends to be reduced.

In this embodiment, the thermally insulative liner tends to reinforce or support the closing flaps of the box 400. Thus, a want for the box 400 or other outer packaging of the packaging to be particularly robust or reinforced tends to be reduced. This tends to allow for reduced cost of manufacture of the box 400 or other outer packaging.

In the above embodiments, the box is substantially cuboidal in shape when the closing flaps seal the opening. More specifically, in the above embodiments, the box comprises four sidewalls, a base and a unitary box lid. However, in other embodiments, there may be a different number of sidewalls, for example three sidewalls, five sidewalls, six sidewalls, seven sidewalls, or eight sidewalls, thereby to define a non-cuboidal shape of the box.

In the above embodiments, the box comprises substantially linear or straight sidewalls. However, in other embodiments, there may be a number of curved sidewalls, for example one continuous curved sidewall or two continuous curved sidewalls.

In the above embodiments, the thermally insulative liner defines a substantially cuboidal enclosed volume, upon assembly, in its closed configuration. However, in other embodiments, the first part and the second part are shaped to define an enclosed volume of a different shape.

In the above embodiments, the first and second parts of the thermally insulative liner have the dimensions described above. However, in other embodiments, one or both of the first and second parts of the liner may have one or more dimensions that is different to those described in the embodiments above.

In the above embodiments, the parts of the thermally insulative liner are formed of elongate sheets comprising a honeycomb core sandwiched between flat sheet layers. However, in other embodiments, the parts of the thermally insulative liner may be formed of sheets comprising a different arrangement of layers. In some embodiments, the parts of the thermally insulative liner may be formed of elongate sheets comprising layers other than a honeycomb core or flat sheets. In some embodiments, the elongate sheets may comprise a honeycomb core and flat sheets in an arrangement other than a sandwiched arrangement. For example, in some embodiments, the parts of the thermally insulative liner may be formed of elongate sheets comprising corrugated or fluted sheets. For example, in some embodiments, the parts of the thermally insulative liner may be formed of elongate sheets comprising air cavities, solid material, or some other insulative material. For example, in some embodiments, the parts of the thermally insulative liner may be formed of elongate sheets comprising a plurality of honeycomb cores and flat, corrugated, or fluted sheets, the cores and sheets being configured in alternating sandwiched arrangement within the elongate sheet.

In the above embodiments, the parts of the thermally insulative liner are formed of elongate sheets of cellulose fibre material. However, in other embodiments, the parts of the thermally insulative liner are formed of sheets of a different material other than cellulose fibre material, for example a composite fibre material, or for example a polymer material.

In some embodiments, the honeycomb core of each part may be of a greater width or thickness than the respective flat sheets of each part. In other embodiments, the honeycomb core of each part may be of smaller width or thickness than the respective flat sheets of each part.

In the above embodiments, the first/further first part not including the segments forming the handle is formed of four segments. In particular, in the above embodiments, the first part is formed of five segments, of which the fifth segment alone forms the handle of the cover, the cover consisting of the third, fourth and fifth segments. In other embodiments, however, the first part may be formed of another number of segments, for example four segments, six segments, seven segments, or eight segments.

In particular, in the above embodiments, the further first part is formed of seven segments, of which three segments form the handle of the cover, the cover consisting of five segments. In other embodiments, however, the further first part may be formed of another number of segments, for example six segments, eight segments, nine segments, or ten segments.

In such other embodiments, different segments, or a different number of segments, than those in the above embodiments of the first/further first part may form the cover of the thermally insulative liner. The cover of the thermally insulative liner may be formed, for example, of four segments, of six segments, or of seven segments.

In such other embodiments, different segments, or a different number of segments, than those in the above embodiments of the first/further first part may form the handle of the cover of the thermally insulative liner. The handle of the cover of the thermally insulative liner may be formed, for example, of two segments, of four segments, or of five segments.

In the above embodiments, the cover of the first/further first part is formed of two segments and additional segments that comprise the handle of the cover. However, in other embodiments, the cover of the first/further first part is formed of a different number of segments and additional segments that comprise the handle of the cover. For example, the cover of the first/further first part may be formed of one segment and additional segments that comprise the handle of the cover, of three segments and additional segments that comprise the handle of the cover, or of four segments and additional segments that comprise the handle of the cover.

In the above embodiments, the second part is formed of three segments. In other embodiments, however, the second part may be formed of another number of segments, for example one segment, two segments, or four segments. In such embodiments, the number of segments that form the second part of the liner is a number of segments associated with the number of segments that form the first/further first part of the liner, such that the liner may fully line a corresponding box.

In the above embodiments, the first/further first part and the second part are separately formed, i.e., not unitarily formed of the same elongate sheet of material. In other embodiments, however, the first/further first part and the second part may be unitarily formed of the same elongate sheet, or of the same material of a different shape or arrangement than that of the above embodiments.

In the above embodiments, the box lined by the thermally insulative liner comprises two closing flaps that assist in closing the cover of the liner, i.e., that help provide some auto-sealing character to the liner. However, in other embodiments, the box lined by the thermally insulative liner comprises a different number of closing flaps, for example one, three, or four. In other embodiments still, the box lined by the thermally insulative liner may have no closing flaps, and the unitary box lid may not be formed, or may be formed by a lid or cover separate to the box.

1. A thermally insulative liner for packaging, the thermally insulative liner comprising:
a base;
a plurality of sidewalls extending from the base, the plurality of sidewalls defining an opening to an internal volume, the opening being opposite to the base; and
a cover configured to cover the opening, wherein:
the cover comprises a first segment, a second segment, and a third segment;
a first side of the first segment is hingedly attached to a first sidewall of the plurality of sidewalls such that the first segment is rotatable, from a position in which the first segment is parallel to and aligned with the first sidewall, in a first direction relative to the first sidewall;
a first side of the second segment is hingedly attached to a second side of the first segment opposite to the first side of the first segment such that the second segment is rotatable, from a position in which the second segment is parallel to and aligned with the first segment, in the first direction; and
a first side of the third segment is hingedly attached to a second side of the second segment opposite to the first side of the second segment such that the third segment is rotatable, from a position in which the third segment is parallel to and aligned with the second segment, in a second direction opposite to the first direction.

2. The thermally insulative liner of claim 1, wherein the thermally insulative liner comprises:
a first part; and
a second part separate from the first part, wherein:
the first part comprises the base, the first sidewall, and the cover, wherein the base, the first sidewall, and the cover are attached together; and
the second part comprises the plurality of sidewalls other than the first sidewall, wherein the plurality of sidewalls other than the first sidewall are attached together.

3. The thermally insulative liner of claim 1, wherein a first side of the first sidewall is hingedly attached to the base such that the first sidewall is rotatable, from a position in which the first sidewall is parallel to and aligned with the base, in the first direction.

4. The thermally insulative liner of claim 1, wherein:
the plurality of sidewalls further comprises a second sidewall, a third sidewall and a fourth sidewall;
a side of the second sidewall is hingedly attached to a first side of the third sidewall such that the third sidewall is rotatable, from a position in which the third sidewall is parallel to and aligned with the second sidewall, in a third direction;
a side of the fourth sidewall is hingedly attached to a second side of the third sidewall opposite the first side of the third sidewall such that the fourth sidewall is rotatable, from a position in which the fourth sidewall is parallel to and aligned with the third sidewall, in the third direction.

5. The thermally insulative liner of claim 1, wherein the base, the plurality of sidewalls, and the cover each comprise a cellular structure comprising a plurality of substantially sealed cells.

6. The thermally insulative liner of claim 5, wherein the cellular structure is a structure selected from the group of structures consisting of a honeycomb structure and a prismatic columnar structure.

7. The thermally insulative liner of claim 5 or 6, wherein each cellular structure is sandwiched between a respective first sheet and a respective second sheet.

8. The thermally insulative liner of claim 7, wherein each hinged attachment is by a respective hinge formed by a slit through the cellular structure and only one of the respective first sheet and the respective second sheet.

9. The thermally insulative liner of claim 2, wherein:
the base, the plurality of sidewalls, and the cover each comprise a cellular structure comprising a plurality of substantially sealed cells;
each cellular structure is sandwiched between a respective first sheet and a respective second sheet;
each hinged attachment is by a respective hinge formed by a slit through the cellular structure and only one of the respective first sheet and the respective second sheet; and
for at least one of the first part or the second part, all of the slits of that part are substantially parallel to each other.

10. The thermally insulative liner of claim 1, wherein the thermally insulative liner comprises one or more materials selected from the group of materials consisting of: a recycled material, a recyclable material, a biodegradable material, paper, card, cardboard, wood, polymer, and a cellulose fibre material.

11. Thermally insulative packaging comprising:
outer packaging defining an internal volume; and
the thermally insulative liner of claim 1 located within the internal volume of the outer packaging.

12. The thermally insulative packaging of claim 11, wherein the outer packaging is a box comprising:
a box base;
a plurality of box sidewalls extending from the base, the plurality of box sidewalls defining a box opening to the internal volume of the outer packaging, the box opening being opposite to the box base; and
a box cover configured to cover the box opening.

13. The thermally insulative packaging of claim 12, wherein, when the box cover is arranged to cover the box opening, the third segment is disposed between the box cover and the second segment, such that the box cover and the second segment are spaced apart thereby to define a cavity therebetween.

14. The thermally insulative packaging of claim 12, wherein:
the box cover comprises a plurality of flaps hingedly attached to respective box sidewalls; and
when the plurality of flaps is arranged to cover the box opening, the third segment is disposed between each of the flaps and the second segment.

15. A method of assembling thermally insulative packaging, the method comprising:
providing outer packaging, the outer packaging defining an internal volume; and
inserting the thermally insulative liner according to claim 1 into the internal volume of the outer packaging.

16. The method of claim 15, wherein:
the thermally insulative liner comprises:
a first part; and
a second part separate from the first part, wherein:
the first part comprises the base, the first sidewall, and the cover, wherein the base, the first sidewall, and the cover are attached together; and
the second part comprises the plurality of sidewalls other than the first sidewall, wherein the plurality of sidewalls other than the first sidewall are attached together; and
the method comprises:
inserting the first part into the internal volume of the outer packaging such that:
the base is disposed against a base of the outer packaging;
the first sidewall is disposed against a sidewall of the outer packaging; and
the first section, the second section, and the third section of the cover are each substantially parallel with the first sidewall; and
inserting the second part into the internal volume of the outer packaging such that each sidewall of the second part is disposed against a respective sidewall of the outer packaging.

17. The method of claim 16, further comprising, thereafter, inserting goods into the internal volume of the thermally insulative liner.

18. The method of claim 16, further comprising, thereafter:
closing, by the cover, the opening of the thermally insulative liner; and
closing, by a further cover of the outer packaging, a further opening to the internal volume of the outer packaging.

19. The thermally insulative liner of claim 2, wherein a first side of the first sidewall is hingedly attached to the base such that the first sidewall is rotatable, from a position in which the first sidewall is parallel to and aligned with the base, in the first direction.

20. The thermally insulative liner of claim 2, wherein the base, the plurality of sidewalls, and the cover each comprise a cellular structure comprising a plurality of substantially sealed cells.
